(19) United States
(12) Patent Application Publication
(10) Pub. No.: US 2002/0029421 A1
(43) Pub. Date: Mar. 14, 2002

(54) Viscous liquid cushions

(76) Inventor: Joel L. Sereboff, Owings Mills, MD (US)

Correspondence Address: David C. Jenkins, Eckert Seamans Cherin & Mellott, LLC, 44th Floor, 600 Grant Street, Pittsburgh, PA, 15219, US

(21) Appl. No.: 09/834,122

(22) Filed: Apr. 12, 2001

Related U.S. Application Data
(60) Provisional application No. 60/196,644, filed on Apr. 12, 2000.

(51) Int. Cl. B68G 5/00; A47C 16/00; A47C 20/02

(52) U.S. Cl. 5/654

(57) ABSTRACT

A cushion with a body having a plurality of regions. The body has a wall forming a plenum. A viscous liquid is disposed within the plenum. The body also includes a structure for restricting the migration of the viscous liquid between the regions of the body.

### CROSS REFERENCE TO RELATED APPLICATIONS

This Application claims the benefit of U.S. Provisional Application Ser. No. 60/196,644 filed Apr. 12, 2000.

### BACKGROUND OF THE INVENTION

1. Field of the Invention

This application relates to viscous liquid cushions and, more specifically, to viscous liquid cushions having multiple chambers so that the viscous liquid is restrained from migrating within the cushion whenever a force is applied.

1. Description of the Related Art

The present invention provides cushions and improvements thereto which are composed of viscous liquids as described in this inventor's U.S. Pat. Nos. 5,590,430 and 5,475,882 (both having the title “Gel filled deformable cushion and composition contained therein”) and which are incorporated herein by reference, as well as cushions containing liquid silicone, and various liquid and semi-solid gels such as visco elastic and/or block polymer gels.

In accordance with the invention, any or all of these materials are sealably contained within elastomeric films, which are sealed as by heat sealing or welding. They are, in this application, referred to as support materials.

The disclosures of such cushions as described in this inventor's U.S. Pat. No. 5,303,977 (“Fluid cushion system”), 5,195,199 (“Fluid cushion”) and of support or orthopedic devices, as described in U.S. Pat. No. 5,356,099 (“Wrist support system”); 5,141,489 (“Cervical brace”); 5,776,088 (“Support device and associated method”); and 5,976,098 (“Support device method”) are also incorporated herein by reference. In addition to these, this inventor has conceived and has applied for U.S. patents, currently pending, for devices which may mitigate or prevent trauma to the body of a member of the animal kingdom. The disclosures of those applications are incorporated by reference as well.

In those cushions which may be used in types of seating as described in this inventor's prior patents, or for any seating where comfort or prevention of irritation, body sores, pressure sores or dicubitus ulcers is a consideration (e.g. bikes, motorcycles, boats, task seating, office seating, or residential seating) the support material may be caused by externally imposed forces to pool or displace between the legs of the person sitting thereon. Such support material may also pool or displace to the area of the seat supporting the coccyx.

There is, therefore, a need for a viscous liquid cushion that is resistant to fluid migration.

There is a further need for a viscous liquid cushion that can be easily manufactured.

### SUMMARY OF THE INVENTION

These needs and others are met by the disclosed invention which provides a viscous liquid cushion having multiple, separate chambers. To prevent fluid migration and to control the areas in which the support material is permitted to reside, to reduce the weight of the seat, and to reduce the cost by decreasing the amount of support material required, one aspect of the present invention disclosure provides for “sealed off” areas between the legs and in the area of the coccyx. The “sealed off” area in one embodiment of the invention leaves the elastomeric material intact in the “sealed off” area and prevents any of the support material from entering the area when forces are externally imposed by the user. In another embodiment, the elastomeric material may be removed from the “sealed off” area and replaced with low density foam or with visco elastic gel or may be simply left empty.

In existing cushions, which are heat sealed at the perimeter, a tension is created on the elastomeric film when external forces are imposed upon the cushion. Such tension interferes with the user's experience of the comfort and pressure-reduction qualities of the support material housed within the cushion. A side wall can be created to enable a better interface between the user and the cushion; however this is an expensive solution to the problem, requiring additional film, seals, and labor. A more effective solution to improving the contact between the user and the padding material is, in accordance with another aspect of the present invention disclosure, to configure the surface of the elastomeric film with a plurality of “bubbles.” The bubbles may be of various shape. Such bubbles are desirably vacuum formed in the sheets of elastomeric film and can be cut to the shape of the cushion being formed through heat-sealing of top and a bottom sheet of elastomeric film. The bubbles may be on the top side of the cushion, the bottom side or on both sides. The depth of the bubbles may be in the range from 1/16 inch to three inches. The support medium thus has an opportunity to flow up into the space created by the bubble and relieve strain on the film and on the perimeter seal.

Another aspect of the present invention disclosure, providing improvement over existing liquid cushions, would involve the insertion of a piece of rubber, block polymer or visco elastic gel or foam (closed cell or fully reticulated) into a central pouch created by the joining of two layers of liquid cushions sealed at their perimeters by heat sealing or welding. Such a configuration is an improvement over single or double layered fluid cushions and provides for greater comfort, measurably less pressure loading on the body and mitigation of trauma forces externally imposed upon the body. After the sheet of foam is inserted into the pouch, a final seal allows it to be contained within the cushion between the two liquid layers. The central layer of foam or semi-solid gel will also provide improved structural integrity to the cushion and prevent collapsing when forces are externally imposed.

Such a central chamber may also be provided with magnets and/or an electrical means to vibrate the cushion or to convey heat or electrical impulses to the body of the user through the neighboring fluid cushion compartments. The magnets or electrical stimulation pads may be enclosed within the central layer or may be immediately adjacent thereto. Such magnets or electrical stimulation pads may be encased in various positions on the elastomeric film enclosing the outer chambers.

Where the purpose of the multi-chambered cushion is to convey heat or electrical stimulation to the body, the liquid composition would then contain particles (such as silver coated microspheres) which could conduct or enable the conduction of the electrical current. A fine gauge wire would carry the current from the power source through the liquid medium.

In a portable version of such a cushion, the power source would be batteries worn on the body of the user or attached to the cushion. Another embodiment of the cushion is for its use in physical therapy. In such an embodiment, pockets are provided in the elastomeric material for tran-cutaneous electrical stimulation. Utilizing the fluid cushion, therapeutic stimulation can, with reduction of pressure on the body and with increased comfort, be provided to patients while they are seated in chairs or while they are driving automobiles. The electrical power for such therapeutic stimulation would desirably be provided by standard “TENS” units in physical therapy or chiropractic offices or through portable battery-powered units.

Stimulation is delivered to the body through moistened pads, which are desirably held to the cushion by slots or equivalent means. Such cushions may be mounted on treatment tables or imbedded in mattresses. Audio speakers can be attached by slots or equivalent means to the elastomeric film to enable the user to listen to audio instructional tapes or to listen to music.

Therefore, it is an object of this invention to provide a viscous liquid cushion having a plurality of regions that is resistant to migration of the viscous liquid between the regions.

It is a further object of this invention to provide a viscous liquid cushion that can be easily manufactured.

It is a further object of this invention to provide a cushion with a body having a plurality of regions, the body having a first wall forming a plenum, a viscous liquid disposed within the plenum, and a means for restricting the migration of the viscous liquid between the regions of the body.

### BRIEF DESCRIPTION OF THE DRAWINGS

These and other advantages of the present invention will become readily apparent upon consideration of the following detailed description and attached drawings, wherein:

FIG. 1 is a top view of one embodiment of the cushion.

FIG. 2 is a cross-sectional view of the cushion taken along line 2-2 in FIG. 1.

FIG. 3 is a top view of another embodiment of the cushion.

FIG. 4 is a cross-sectional view of the cushion taken along line 4-4 in FIG. 3.

FIG. 5 is an isometric view of another embodiment.

FIG. 6 is a cross-sectional view of another embodiment.

### DESCRIPTION OF THE PREFERRED EMBODIMENT

As used herein, “wall” means a barrier made from an elastomeric film.

As used herein, “viscous liquid” means liquid silicone, gels including, but not limited to, the gel disclosed in U.S. Pat. No. 5,590,430, semi-solid gels, visco-elastic gels, and block polymer gels.

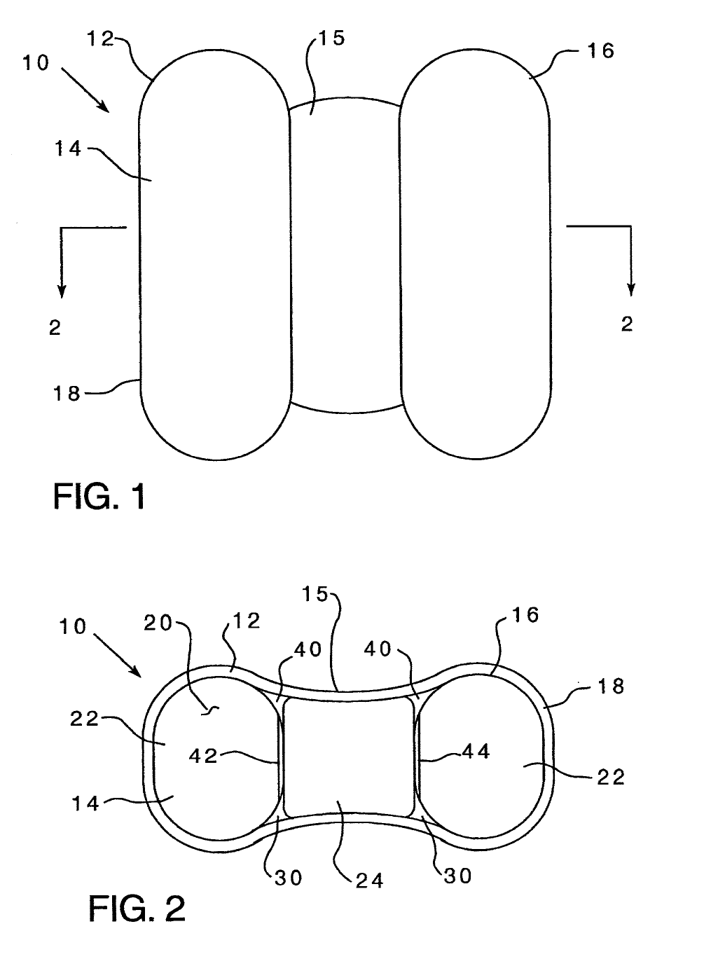

As shown in FIGS. 1 and 2, a cushion 10 includes a body 12 having a plurality of regions 14, 15, 16. The body 12 is formed from a wall 18. The wall 18 forms a plenum 20. The plenum 20 is substantially filed with a viscous liquid 22. The cushion 10 further includes a means 30 for restricting the migration of the viscous liquid between the regions of the body 14, 15, 16.

In one embodiment, the means 30 for restricting the migration of the viscous liquid between the regions of the body 14, 15, 16 includes a plurality of partition walls 40. As shown in FIGS. 1 and 2, the cushion 10 is sized as a seat for a human. The cushion 10 includes a first leg region 14, a second leg region 16 and a medial region 15. The medial region 15 is disposed between the first leg region 14 and the second leg region 16. The regions 14, 15, 16 are configured so that, when a user sits on the cushion 10, one leg is disposed on the first leg region 14 and the other leg is disposed on the second leg region 16. The medial region 15 is, therefore, disposed between the user's legs. The partition walls are heat welded to the body wall 18 thereby sealing off the medial region 16. That is, not only is fluid migration restricted, there can be no migration between the plenum regions 14, 15, 16.

The plurality of partition walls 40 includes a first partition wall 42 disposed between the first leg region 14 and the medial portion 15. The plurality of partition walls 40 also includes a second partition wall 44 disposed between the second leg region 16 and the medial portion 15. The partition walls 42, 44 are coupled to the body wall 18 as to form a seal. Thus, the viscous liquid 22 cannot migrate between the first leg region 14 and the second leg region 16 to the medial region 15. The medial region 15 may be filled with a material 24 such as air, a visco-elastic gel or foam.

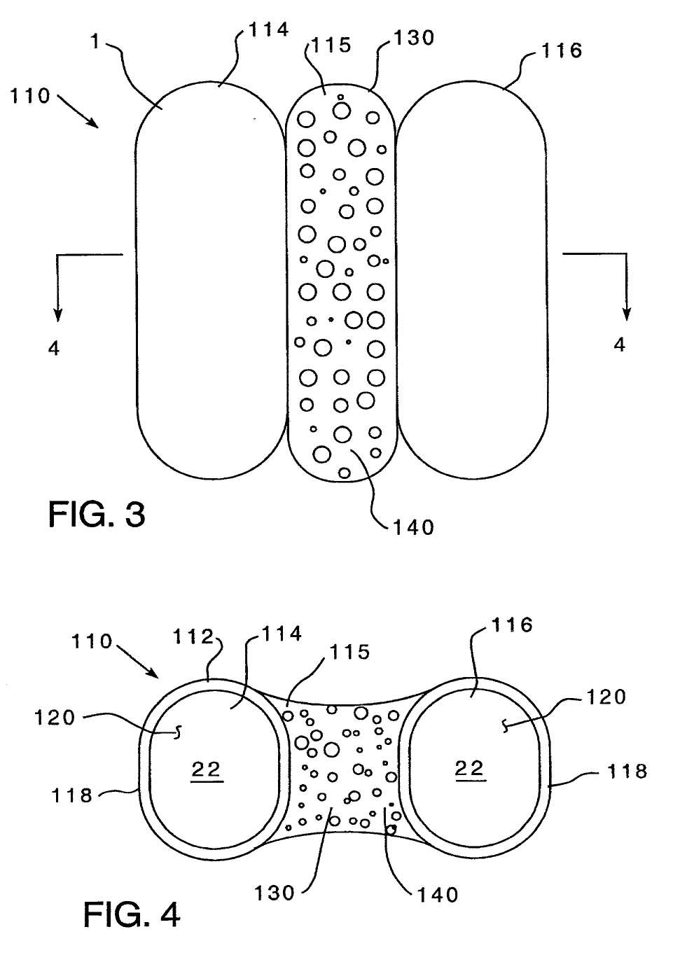

In a second embodiment, shown in FIGS. 3 and 4, the cushion 110 includes a body 112 having a plurality of regions 114, 115, 116. The body 112 is formed from a wall 118. The wall 118 forms a plenum 120. The plenum 120 is substantially filed with a viscous liquid 22. The cushion 110 further includes a means 130 for restricting the migration of the viscous liquid 22 between the regions of the body 114, 115, 116.

In this embodiment, the means 130 for restricting the migration of the viscous liquid between the regions of the body 114, 115, 116 is a foam pad 140. The cushion 110 is sized as a seat for a human. The cushion 110 includes a first leg region 114, a second leg region 116 and a medial region 115. The medial region 115 is disposed between the first leg region 114 and the second leg region 116. The regions 114, 115, 116 are configured so that, when a user sits on the cushion 110, one leg is disposed on the first leg region 114 and the other leg is disposed on the second leg region 116. The medial region 115 is, therefore, disposed between the user's legs and acts as a means 130 to restrict the migration of the viscous liquid 22. That is, because the foam pad 140 bisects the plenum 120, the viscous liquid 22 cannot migrate between the first leg region 114 and the second leg region 116, or to the medial region 115.

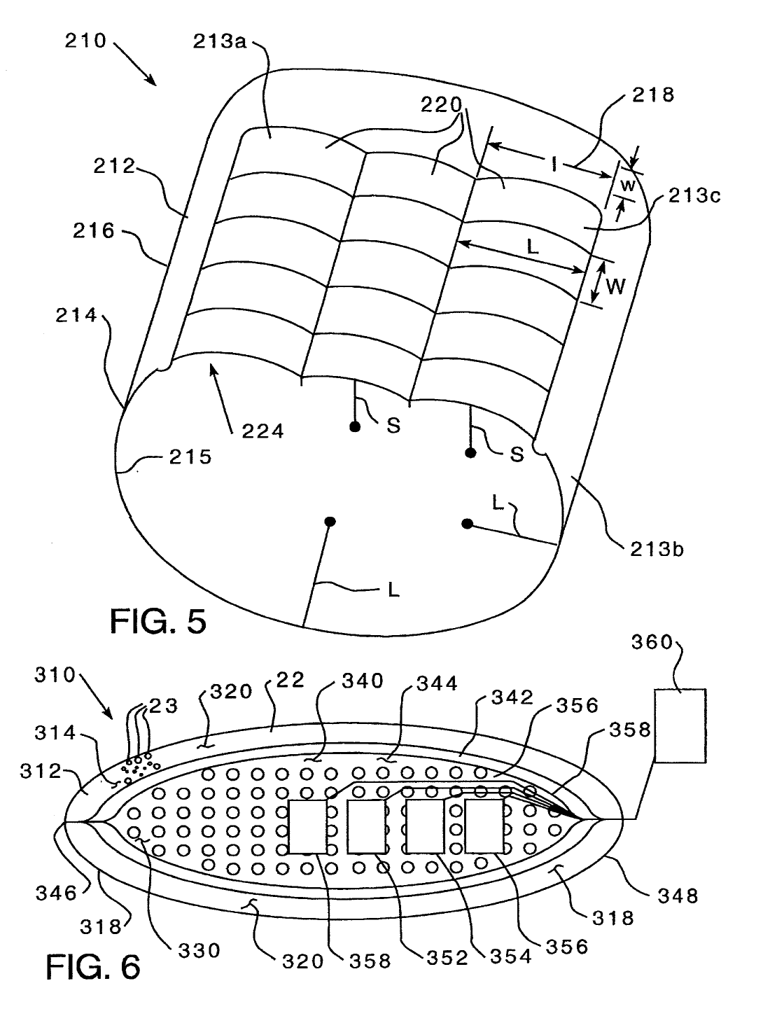

As shown in FIG. 5, in another embodiment of the cushion 210, the body 212 is formed of a wall 214. The wall 214 forms a generally elliptical cylinder having one or more large radii as indicated by the letter “L.” The body 212 has different regions 213a, 213b, 213c. The wall 214 has an inner surface 215 and an outer surface 216. The body wall 214 forms a plenum 217. As used herein, “outer surface 216” indicates the surface outside of the plenum 217. The cushion 210 may, however, be formed as a tube, e.g., to support an injured finger, and the inner surface of the tube is an “outer surface” relative to the plenum 217. The body outer surface 216 has a plurality of sections 218 each with a first surface area. As shown on figure the sections are identified as a marked rectangular area having a length “1,” and width “w,” the sections, however, are not necessarily marked and may be simply a portion of the wall 214. A plurality of bubbles or pockets 220 formed in wall 214 and extend outwardly. The pockets 220 are formed as an expanded, arcuate portion 222 of the body wall 214 each having a small radius, as indicated by the letter “S”. The arcuate portions may be generally cylindrical or may have an elliptical shape. As such the smaller radius “S” does not indicate that the arcuate portion 222 must be cylindrical or spherical. The arcuate portions have the a substantially similar length “1” and width “w” as a section 218. Each pocket 220 forms a pocket plenum 224. Each pocket 220 has a second surface area that is substantially smaller than the total surface area of body wall 214. However, each pocket 220 second surface area is larger than the first surface area of a section 218. That is, although the arcuate portions 222 and the sections 218 have the same length and width, a section 218 is relatively flat, having a curvature that is a function of a large radius “L”. Conversely, the arcuate portion 222 has a greater curvature that is a function of the smaller radius “S”. As such, the second surface area of the arcuate portion 222 is larger than the first surface area than a wall section 218. Each pocket 220 may be between about 1/16 of an inch to 3 inches deep.

The body plenum 217 is substantially filled with a viscous liquid 22. Some of the viscous liquid 22 in the body plenum 217 flows into each pocket plenum 224. The viscous liquid 22 tends to become trapped in a pocket plenum 224, therefore, the viscous liquid 22 is restricted from moving from one cushion region 213a, 213b, 213c to another. Because the viscous liquid 22 is viscous, it will not rapidly flow from the pocket plenum 224 into the body plenum 217 when a force is applied or into another pocket plenum 224. Thus, the plurality of pockets 220 acts as a means for restricting migration of the viscous liquid 22 because viscous fluid 22 within one pocket plenum 220 in one body region 213a, 213b, 213c is restricted from migrating to another body region 213a, 213b, 213c. Additionally, because the surface area of each pocket 220 is greater than the surface area of the associated section 218, when a user places pressure on the cushion 210, e.g., by sitting on the cushion 230, the distribution of the user's weight over the greater surface area of the pockets acts to reduce the stress on the body wall 214. When there is less stress on the body wall 214, a greater area of the cushion 210 will contact the user and more evenly support the user.

As shown in FIG. 6, in another embodiment, the cushion 310 has body 312 having a plurality of regions 314, 316. The body 312 is formed from a wall 318. The wall 318 forms a plenum 320. The plenum 320 is substantially filed with a viscous liquid 22. The cushion 310 further includes a means 330 for restricting the migration of the viscous liquid between the regions of the body 314, 316. In this embodiment, the means 330 for restricting the migration of the viscous liquid 22 between the regions of the body 314, 316 includes a pouch 340 disposed within the plenum 320. The pouch 340 is formed from a wall 342. The pouch wall 342 forms an inner plenum 344. The body plenum 320 has a first cross-sectional area. Preferably, the pouch 340 has a second cross-sectional area that is substantially the same size as the body plenum 320 first cross-sectional area. Thus, the pouch 340 may be coupled to the body wall 318 at two edge points 346, 348. Alternatively, the pouch 340 may be formed by joining, e.g. by heat sealing, two layers of viscous liquid filled cushions. In this configuration, the pouch 340 effectively forms a central chamber which separates the body plenum 320 into an upper plenum region 314 and a lower plenum region 316. Thus, the pouch 340 acts as a means to restrict the migration of the viscous liquid 322 between the upper plenum region 314 and the lower plenum region 316.

The pouch 340, preferably is filled with a compressible material 350, such as a foam pad 351 or a semi-solid gel. The compressible material 350 may be used to support one or more devices such as at least one heating device 352, at least one vibrating device 354, at least one magnet 356, at least one electrical stimulation device 358, or any combination thereof. If required, a wire 358, connected to a power supply 360, may extend through the body wall 320 and the pouch wall 342 and be coupled to the heating device 352, the vibrating device 354, and/or the electrical stimulation device 358. The viscous fluid 22 may include metallic particles 23, such as silver coated microspheres. The particles 23 convert the cushion 310 into a conductive body and aid in the transmission of heat or electrical stimulation.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A cushion comprising:
a body having a plurality of regions;
said body having a first wall forming a plenum;
a viscous liquid disposed within said plenum; and
a means for restricting the migration of said viscous liquid between said regions of said body.

2. The cushion of claim 1 wherein:
said body is generally sized as a seat for a human;
said body having a first leg region, a second leg region, and a medial region disposed between said first leg region and said second leg region;
said means for restricting the migration of said viscous liquid between said regions of said body includes a plurality of partition walls disposed within, and sealed to, said body wall;
wherein a first partition wall is disposed between said first leg region and said medial region, and a second partition wall is disposed between said second leg region and said medial region; and
whereby viscous liquid cannot migrate from said first leg region or said second leg region into said medial region.

3. The cushion of claim 1 wherein:
said body is generally sized as a seat for a human;
said body having a first leg region, a second leg region, and a medial region disposed between said first leg region and said second leg region;
said means for restricting the migration of said viscous liquid between said regions of said body includes:
said body wall encompassing said first leg region and said second leg region;
said body wall having an outer surface; and
a foam pad disposed in said medial region and coupled to said body wall outer surface at both said first and second leg regions; and
whereby viscous liquid cannot migrate from said first leg region or said second leg region into said medial region.

4. The cushion of claim 1 wherein:
said means for restricting the migration of said viscous liquid between said regions of said body includes:
a plurality of pockets disposed on said body wall;
said pockets having a surface area substantially less than the total surface area of said body wall;
each said pocket formed of an expanded arcuate portion of said body wall;
each said arcuate portion forming a pocket plenum;
whereby said viscous liquid may migrate between said body plenum and each said pocket plenum, but said viscous fluid within one pocket plenum in one body region is restricted from migrating to another body region.

5. The cushion of claim 4 wherein:
said body wall includes a plurality of sections, each said section having a length, a width and a first surface area;
each said arcuate portion having a length, width a second surface area;
said section and arcuate portion length and width being substantially similar;
said arcuate portion having a greater curvature than said body wall; and
and said second surface area being greater than said associated body wall section first surface area.

6. The cushion of claim 4 wherein said pockets have a radius between about 1/16 of an inch to 3 inches.

7. The cushion of claim 1 wherein:
said means for restricting the migration of said viscous liquid between said regions of said body includes:
a pouch disposed within said body plenum;
said pouch formed by a wall and having an inner plenum; and
a foam pad disposed within said pouch.

8. The cushion of claim 1 wherein:
said means for restricting the migration of said viscous liquid between said regions of said body includes:
a pouch disposed within said body plenum;
said pouch formed by a wall and having an inner plenum; and
a semi-solid gel is disposed within said pouch.

9. The cushion of claim 7 or 8 wherein said pouch is sealed within the body wall.

10. The cushion of claim 7 wherein:
said body plenum has a first cross-sectional area;
said pouch has a second cross-sectional area that is substantially the same size as said body plenum first cross-sectional area;
whereby said pouch defines a central chamber within said body plenum which separates said body plenum into an upper plenum region and a lower plenum region.

11. The cushion of claim 10 wherein said foam pad includes at least one heating device.

12. The cushion of claim 10 wherein said foam pad includes at least one vibrating device.

13. The cushion of claim 10 wherein said foam pad at least one electrical stimulation device.

14. A cushion comprising:
a body having a plurality of regions;
said body having a first wall forming a plenum;
said body wall having an outer surface;
a viscous liquid disposed within said plenum;
a plurality of pockets disposed on said body wall;
said pockets having a surface area substantially less than the total surface area of said body wall;
each said pocket formed of an expanded arcuate portion of said body wall;
each said arcuate portion forming a pocket plenum;
whereby said viscous liquid may migrate between said body plenum and each said pocket plenum, but said viscous fluid within one pocket plenum in one body region is restricted from migrating to another body region.

15. The cushion of claim 14 wherein:
said body wall includes a plurality of sections, each said section having a length, a width and a first surface area;
each said arcuate portion having a length, width a second surface area;
said section and arcuate portion length and width being substantially similar;
said arcuate portion having a greater curvature than said body wall; and
and said second surface area being greater than said associated body wall section first surface area.

16. The cushion of claim 14 wherein said pockets are between about 1/16 of an inch to 3 inches deep.
